(19) United States
(12) Patent Application Publication
(10) Pub. No.: US 2007/0206751 A1
(43) Pub. Date: Sep. 6, 2007

(54) INCOMING CALL DISPLAY SYSTEM

(76) Inventor: Cheng-Wen Hsu, Tao-Yuan Hsien (TW)

Correspondence Address: NORTH AMERICA INTELLECTUAL PROPERTY CORPORATION, P.O. BOX 506, MERRIFIELD, VA, 22116, US

(21) Appl. No.: 11/674,653

(22) Filed: Feb. 13, 2007

(30) Foreign Application Priority Data
Feb. 23, 2006 (TW) 095106141

(51) Int. Cl. H04M 15/06; H04M 1/56

(52) U.S. Cl. 379/142.02

(57) ABSTRACT

A display system for showing incoming call messages is introduced. The display system includes a monitor, a telephone plug coupled to a telephone signal source, and a microprocessor for controlling the display to show an incoming call message when an incoming call signal is received from the telephone signal source. The display enables users to notice incoming calls without disturbances of ring tones.

### BACKGROUND OF THE INVENTION

1. Field of the Invention

The present invention provides a display device and an incoming call system; in particular a display device that displays incoming call information according to an incoming call signal and an incoming call system that displays incoming call information with the display device.

2. Description of the Prior Art

In general, when receiving a call on either landline phones or mobile phones, the phones alert users with ring tones. However, on some occasions, such as meetings or ceremonies, ring tones annoy the users or sometimes others. Once the ring tone is turned off, the users can easily miss a call, causing inconvenience. At present, there are several landline phones and mobile phones that have screens that flash or blink to display incoming calls, but since the screens of these phones are not always in sight of the users, it is not very useful. At the same time, computers and televisions are commonly owned by households and offices. Even though computers and televisions have bigger screens and are normally placed in obvious places, they do not work in cooperation with the phones to provide a more convenient service.

### SUMMARY OF THE INVENTION

An incoming call display system according to the claimed invention includes a monitor for displaying images, a telephone plug coupled to a telephone signal source, and a microprocessor for controlling the monitor to display incoming call information when the telephone plug receives an incoming call signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a first embodiment of an incoming call display system of the present invention.

FIG. 2 is a diagram of a second embodiment of an incoming call display system of the present invention.

FIG. 3 is a diagram of a third embodiment of an incoming call display system of the present invention.

### DETAILED DESCRIPTION

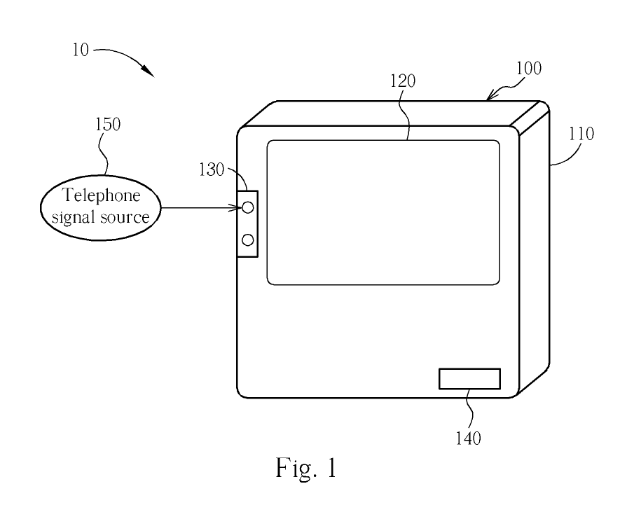

Please refer to FIG. 1. FIG. 1 is a diagram of an incoming call display system 10 of the present invention. The incoming call display system 10 of the present invention comprises a telephone signal source 150 and a display device 100. The display device 100 comprises a housing 110, a monitor 120 installed on the housing 110 for displaying images, a telephone plug 130 installed on the housing 110 for coupling with the telephone signal source 150 in a wired or a wireless manner to receive a telephone signal from the telephone signal source 150, and a microprocessor 140. The display device 100 can be a television set or computer, or a device that cannot decode incoming voice signals from the telephone signal source 150. The display device 100 of the present invention comprises the telephone plug 130 coupled to the telephone signal source 150, with the microprocessor 140 in the display device 100 controlling the monitor 120 to display incoming call information when the telephone plug 130 receives an incoming call signal from the telephone signal source 150. The display device 100 of the present invention is not required to have abilities of processing telephone signals (e.g., receiving calls, dialing calls etc.). The display device 100 only needs the microprocessor 140 to control the monitor 120 to display the incoming call information when an incoming call signal (normally a simple electrical signal, such as a squarewave) is detected. For example, the display device 100 of the present invention can be a computer with the monitor 120 being a liquid crystal display of the computer. A user can turn off a phone's ring tone and still be able to view the incoming call information on the computer monitor without being disturbed by the ring tone.

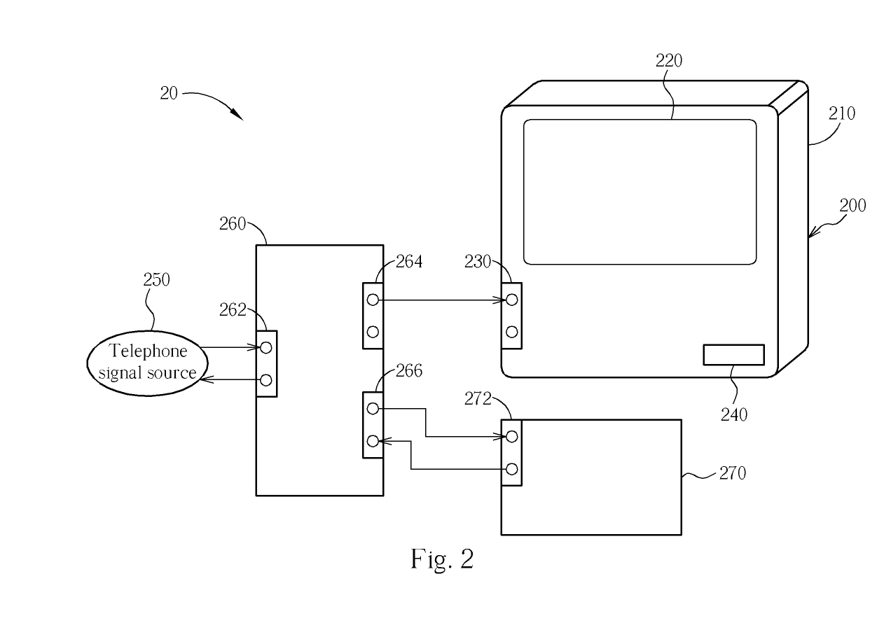

Please refer to FIG. 2. FIG. 2 is a diagram of an embodiment 20 of an incoming call display system in the present invention. The incoming call display system 20 comprises a telephone signal source 250, a display device 200, a distributor 260, and a telephone 270. The display device 200 comprises a housing 210, a monitor 220, a telephone plug 230 for coupling the display device 200 to the telephone signal source 250, and a microprocessor 240, where each of the components and functions are the same as the display device 100 shown in FIG. 1.

The telephone 270 is a conventional telephone and receives and transmits telephone signals through a telephone plug 272. The distributor 260 is coupled to the telephone signal source 250 with an up-stream port 262, coupled to the display device 200 with a first down-stream port 264, and coupled to the telephone plug 272 of the telephone 270 with a second down-stream port 266. When a user does not want to be disturbed by telephone ring tones, the user can turn down or turn off the ringer volume. When the telephone signal source 250 transmits an incoming call signal, the display device 200 of the present invention and the telephone 270 can both receive the incoming call signal through the distributor 260. The microprocessor 240 of the display device 200 controls incoming call information, so that the user can see the incoming call information on the monitor and answer the call with the telephone 270. As shown in FIG. 2 the incoming call display system 20 of the present invention uses a display device which is unable to process incoming voice signals, to display incoming call information, hence the incoming call display system 20 is different from parallel extension lines of the prior art.

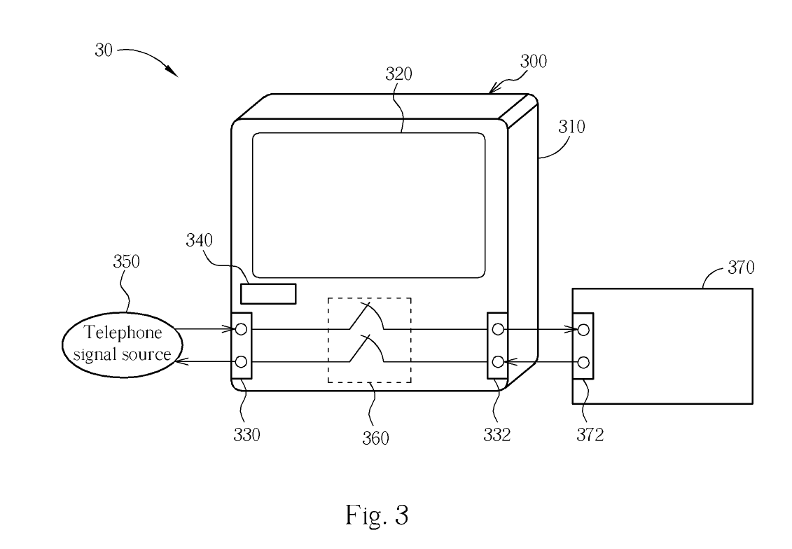

The display device of the present invention can couple to telephones in parallel to form a system. Please refer to FIG. 3. FIG. 3 is a diagram of another embodiment of an incoming call display system 30 according to the present invention. The incoming call display system 30 comprises a telephone signal source 350, a display device 300, and a telephone 370. The display device 300 comprises a housing 310, a monitor 320, a first telephone plug 330 for coupling to the telephone signal source 350, a second telephone plug 332 for coupling to the telephone 370, a microprocessor 340, and a switch 360. The telephone 370 is a conventional telephone which receives and transmits telephone signals through a telephone plug 372 that is electrically connected to the second telephone plug 332 coupled to the display device 300. When a user does not want to be disturbed by telephone ring tones, the user can turn on a switch 360 of the display device 300 to have the second telephone plug 332 electrically disconnected from the telephone signal source 350, meaning that the telephone 370 is not able to receive signals from the telephone signal source 350.

When the telephone signal source 350 transmits an incoming call, the display device 300 of the present invention receives the incoming call information followed by the microprocessor 340 controlling the monitor 320 to display incoming call information, so that the user can view the incoming call information on the monitor. If the user wants to answer the incoming call, the user needs to press (turn off) the switch 360 of the display device 300 to establish a connection between the telephone 370 and the telephone signal source 350 and receive telephone signals from the telephone signal source 350 with the telephone 370. The present embodiment couples the telephone 370 and the display device 300 in series to have an advantage that the user is not required to turn off a ringer in the telephone 370. The ringer in the telephone 370 can remain in an “on” status, since the telephone 370 cannot receive an incoming call signal from the telephone signal source 350 and ring when the switch 360 of the display device 300 is turned on. Obviously, the present invention is also able to have the switch 360 of the display device 300 remain in an “off” status, meaning keeping a connection between the telephone 370 and the telephone signal source 350, and still avoid disturbances from incoming call ring tones by turning off the ringer of the telephone 370. The display device 300 with the microprocessor 340 is able to control the switch 360 or operate the switch 360 through mechanical hardware.

In summary, the present invention takes a display device, without abilities to process telephone signals, to display incoming call information on according to an incoming call signal from a telephone. Thus, a simple and convenient incoming call display system of a telephone is achieved. By extension of functionality of a microprocessor of the display device, the display device might be able to display an incoming call number or other information according to an incoming call signal. The present invention can apply to both landline telephones and mobile phones, or many other different telephone systems, and display incoming calls with the display devices such as televisions, computers, or Personal Digital Assistants (PDAs) etc., electronic devices comprising monitors that cannot process telephone signals. The display device, telephone signal source and the telephone, even the distributor, of present invention can be coupled together in a wired or a wireless manner.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A display device comprising:
a monitor for image displaying;
a telephone plug coupled to a telephone signal source; and
a microprocessor for controlling the monitor to display incoming call information when the telephone plug receives an incoming call signal.

2. The display device of claim 1 further comprising a housing where the monitor is installed on.

3. The display device of claim 1 further comprising a housing where the telephone plug is installed on.

4. The display device of claim 1 being a television.

5. The display device of claim 1 being a computer.

6. An incoming call display system comprising:
a telephone signal source; and
a display device comprising:
a monitor for displaying images;
a first telephone plug coupled to the telephone signal source; and
a microprocessor for controlling the monitor to display incoming call information when the first telephone plug receives an incoming call signal.

7. The incoming call display system of claim 6 wherein the display device further comprises a housing where the monitor is installed on.

8. The incoming call display system of claim 6 wherein the display device further comprises a housing where the first telephone plug is installed on.

9. The incoming call display system of claim 6 further comprising:
a telephone coupled to the telephone signal source wherein the telephone answers and dials phone calls with the telephone signal source.

10. The incoming call display system of claim 9 wherein the telephone and the display device are coupled in parallel.

11. The incoming call display system of claim 10 further comprising:
a distributor comprising:
an up-stream port coupled to the telephone signal source;
a first down-stream port coupled to the first telephone plug of the display device; and
a second down-stream port coupled to the telephone;
wherein the telephone and the display device are able to receive a telephone signal from the telephone signal source through the distributor, and the telephone is also able to transmit the telephone signal to the telephone signal source through the distributor.

12. The incoming call display system of claim 9 wherein the telephone and the display device are coupled in series.

13. The incoming call display system of claim 12 wherein the display device further comprises:
a second telephone plug coupled to the telephone;
wherein the telephone is able to receive a telephone signal from the telephone signal source through the display device, and the telephone is able to transmit the telephone signal to the telephone signal source through the display device.

14. The incoming call display system of claim 13 wherein the display device further comprises a switch, and wherein when the switch is closed, the telephone is coupled to the telephone signal source; and when the switch is opened, the telephone is electrically disconnected to the telephone signal source.

15. The incoming call display system of claim 14 wherein the switch is controlled by the microprocessor of the display device according to a switching signal.

16. The incoming call display system of claim 6 wherein the first telephone plug is coupled to the telephone signal source through a telephone line.

17. The incoming call display system of claim 6 wherein the first telephone plug is coupled to the telephone signal source in a wireless manner.

18. The incoming call display system of claim 6 wherein when the microprocessor receives the incoming call signal, the microprocessor controls the monitor to display the incoming call information.
